(19) United States
(12) Patent Application Publication
(10) Pub. No.: US 2014/0185225 A1
(43) Pub. Date: Jul. 3, 2014

(54) Advanced Datacenter Designs

(71) Applicant: Joel Wineland, Garden Ridge, TX (US)

(72) Inventor: Joel Wineland, Garden Ridge, TX (US)

(21) Appl. No.: 13/729,519

(22) Filed: Dec. 28, 2012

(51) Int. Cl. G06F 1/20

(52) U.S. Cl. CPC G06F 1/20
USPC 361/679.31

(57) ABSTRACT

In an embodiment, a datacenter includes a silo-shaped enclosure defining a shelter from an environment and a plurality of racks having datacenter equipment and configured within the silo-shaped enclosure. The racks are configured in a substantially cylindrical arrangement that defines an interior channel to receive and expel an exhaust airflow communicated from a first side of the plurality of racks to a second side of the plurality of racks abutting the interior channel.

### BACKGROUND

In traditional datacenters, many server computer systems along with other associated networking equipment such as switches, routers, load balancers and so forth are typically implemented in racks or other support structures. Generally a large space is dedicated for the equipment in that a datacenter is housed in a relatively large facility, e.g., extending hundreds of yards, which is filled with racks that require high amounts of cool air to enable proper operation.

Generally, the facilities that house the datacenters are typical warehouse or similar structures such that the length, width and height of the building have no bearing or basis on the size of the racks, which are typically on the order of approximately six feet high, or other support structures implemented within the building. With conventional datacenter designs, many inefficiencies present themselves including inefficiencies in cooling, and inefficiencies in building usage among others.

### SUMMARY OF THE INVENTION

A first aspect is directed to a system including a cylindrical frame having an internal portion surrounding and defining an open cylindrical channel and an external portion at a periphery of the cylindrical frame. The cylindrical frame includes a plurality of racks, at least some of which each support a plurality of servers adapted between the internal portion and the external portion. A source of cooling air may be communicated across the plurality of servers from the external portion to the open cylindrical channel and is exhaust therefrom.

In some embodiments, at least one robotic member can access a server of the plurality of servers via the open cylindrical channel. Each of the racks includes a plurality of midplanes each having a first side accessible by the at least one robotic member and a second side that is accessible from the external portion. In turn, the robotic member may insert a first server to couple to the first side of a first midplane. A second server coupled to a second side of the first midplane may be manually insertable. The first midplane may include connection members to mate with corresponding connection members of the first and second servers and to provide power and a communication path to the corresponding first and second servers.

In an embodiment, an exhaust fan may be located at a top portion of the open cylindrical channel to dissipate heat from the plurality of servers. The cylindrical frame may include a plurality of openings each between pairs of the plurality of racks, where IO cables are configured within the plurality of openings and coupled to corresponding servers of the plurality of servers. The cylindrical frame may include a plurality of openings each between pairs of the plurality of racks, where the plurality of openings include air direction members to direct a flow of the cooling air across a depth dimension of the plurality of servers. In an embodiment, an exterior of the cylindrical frame and the open cylindrical channel are positively isolated via a pressurized air flow.

According to another aspect, a datacenter includes a silo-shaped enclosure defining a shelter from an environment and a plurality of racks having datacenter equipment and configured within the silo-shaped enclosure, where the plurality of racks are configured in a substantially cylindrical arrangement that defines an interior channel to receive and expel an exhaust airflow communicated from a first side of the plurality of racks to a second side of the plurality of racks abutting the interior channel.

The silo-shaped enclosure may include a vent at top portion thereof to outlet the exhaust airflow. The silo-shaped enclosure may be a preformed structure sized minimally larger than the plurality of racks. In turn, the datacenter may include a plurality of silo-shaped enclosures each including a plurality of racks having datacenter equipment.

A still further aspect is directed to a datacenter having: a plurality of racks each configured to support a plurality of rack-mounted datacenter equipment; and an automated storage and retrieval system (AS/RS) system in communication with the plurality of racks. In an embodiment, the AS/RS system includes at least one robotic member, a lateral translator and a vertical translator. The robotic member is controllable to insert a first piece of datacenter equipment into a first location within a first rack of the plurality of racks and to remove a second piece of datacenter equipment from a second location within a second rack of the plurality of racks. This first rack includes at least one blind mate connector at the first location to enable the robotic member to insert the first piece of datacenter equipment. The robotic member may insert a server into the first location during installation of the server into the datacenter, and may remove a second server from the second location responsive to a failure in the second server.

In some embodiments, a building enclosure may house the racks, where the building enclosure is a rack supported structure in which the racks form a super structure of the building enclosure and a plurality of panels are adapted to an exterior of the plurality of racks to form an exterior of the building enclosure.

In one embodiment, each of the plurality of racks further includes a first rail member vertically adapted to a first side of the rack and a second rail member vertically adapted to a second side of the rack, where the first rail member is to supply power to the corresponding plurality of servers and the second rail member is to provide IO communication paths to the corresponding plurality of servers.

Each of the racks includes a plurality of midplanes each having a first face having a power connection member coupled to the first rail member and to couple to a corresponding power connector of a server and a data connection member coupled to the second rail member and to couple to a corresponding data connector of the server. The robotic member may install the server into the first face. The midplanes may further include a second face having a power connection member coupled to the first rail member and to couple to a corresponding power connector of a second server and a data connection member coupled to the second rail member and to couple to a corresponding data connector of the second server, where the second server is manually insertable into the second face.

### BRIEF DESCRIPTION OF THE DRAWINGS

FIG. 1 is a block diagram of an arrangement of at least a portion of a datacenter within a silo in accordance with an embodiment of the present invention.

FIG. 2 is a block diagram that provides further details regarding a rack or support structure in accordance with an embodiment of the present invention.

FIG. 3 is a block diagram of another arrangement of a datacenter in accordance with another embodiment of the present invention.

### DETAILED DESCRIPTION

In various embodiments, different types of support structures and buildings or other enclosures for a datacenter may be provided. These support structures differ from conventional datacenter buildings in that the enclosures may be implemented as silos, cones, domes or other unique shapes that take into account the configuration of the server support structures in their design. Still further embodiments may implement a datacenter using a rack-supported building structure, in that the datacenter facility itself is sized and configured such that rack-based equipment of the datacenter substantially fills the building's dimensions, in all of width, depth and height. And further, at least external portions of the racks or other support structures for the equipment can act as a support structure for the building.

Additional embodiments provide for non-conventional support structures for datacenter equipment including servers, switches, routers, load balancers, storage and other equipment. In addition some embodiments enable automated access to the equipment using an automated storage and retrieval system (AS/RS) system. While particular implementations will be described herein, understand the scope of the present invention is not limited to these particular implementations and embodiments of the concepts described herein apply equally to other non-traditional datacenter designs.

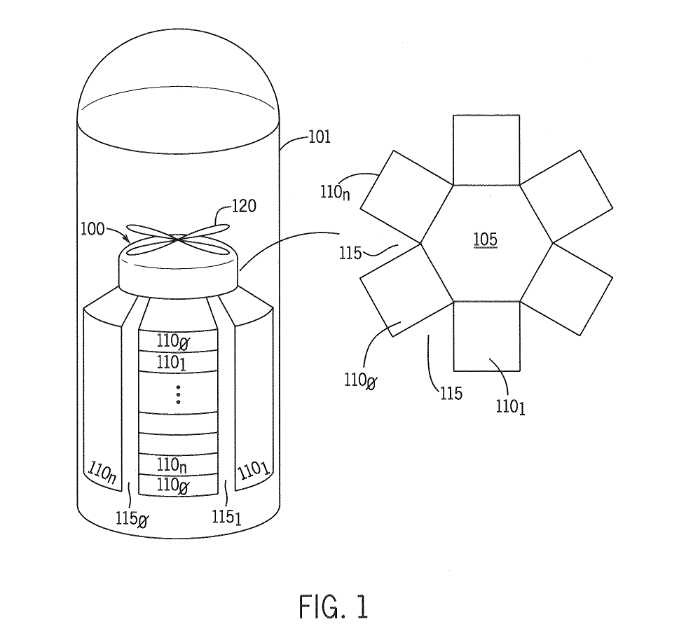

Referring now to FIG. 1, shown is a block diagram of an arrangement of at least a portion of a datacenter within a silo in accordance with an embodiment of the present invention. As shown in FIG. 1, a silo enclosure 101 which may be a building enclosure fabricated in different manners can be configured in a substantially cylindrical arrangement such that it can house a silo-based support structure 100. In general, this support structure can be formed of various metal shelving or other independent support units that collectively form a frame.

In the implementation shown in FIG. 1, structure 100 may include a plurality of racks or other supporting structures 110₀-110ₙ, each of which is configured to support a plurality of servers or other datacenter equipment such as routers, switches, load balancers, storage devices and so forth. For purposes of illustration a plurality of servers 111₀-111ₙ are present in a single rack 110₀. In one embodiment, these servers can be configured as typical rack-mounted servers, each of which is located within a standard U-sized unit. However understand the scope of the present invention is not limited in this regard and many different configurations of supporting structures to support servers and other system components are possible.

Note that due to the cylindrical configuration, a plurality of openings 115 are defined between pairs of the supporting structures 110. In some implementations these may be maintained as open spaces to aid in airflow as discussed further below. In such examples, the sides of racks 110 may have air direction members such as louvers or the like to allow a flow of cool air to be inlet to the equipment across an entire depth of the equipment. In other embodiments, a panel can be mounted on a front and possibly top side to thus close this space off. Still further in other implementations various supporting structures, communication paths such as IO lines, power lines, data lines and so forth may be passed through these openings. As seen in the inset of FIG. 1, which is a top view, these openings may be of generally pie-shape in an embodiment.

As further illustrated in FIG. 1, an internal substantially cylindrical channel 105 (corresponding to the shape of the supporting structures, and thus understand that as used herein the term “cylindrical” encompasses a substantially cylindrical shape such as that shown in FIG. 1) may provide an opening through which exhaust air, namely heated air that dissipates heat created by the equipment, can travel, e.g., in an upward manner and be exhausted out of the enclosure via a fan 120 such as an exhaust fan or other heat radiation mechanism. In many embodiments, a positive air pressure differential between an external periphery of structure 100 and internal channel 105 enables a substantially uniform and lateral laminar flow of cooling air from the external periphery of structure 100 across a depth of the various equipment and into internal channel 105. Then via fan 120, this heated air flow is forced to exit the structure. In some embodiments, fan 120 can communicate the flow of air out of the silo enclosure via a vent or other structure at a top of the enclosure.

Thus in various embodiments, the silo enclosure may be pressurized such that positive isolation is present between the two sides (namely internal and external) portions of support structure 100. As such, one side may be pressurized with a flow of cold air, which passes through the servers and other datacenter equipment within the support structure and allows an exhaust flow of heated air to be communicated through the internal channel.

Furthermore, due to this positive air pressure differential (and the heat within this channel), the internal channel may not be human accessible as instead operators can access equipment as needed via the periphery of the support structure. In addition, embodiments may incorporate an AS/RS system or other robotic and automated manipulators to allow select equipment to be accessed in an automated manner, e.g., to aid in installation, maintenance and removal operations that can be automatically controlled. In some embodiments, the AS/RS robotic member within the internal channel may be implemented on a pole or other support member such that the robotic member can vertically traverse the pole and axially rotate to access a given piece of equipment in one of the structures 110. Although shown at this high level in the embodiment of FIG. 1, understand the scope of the present invention is not limited in this regard.

For example, other cooling systems are possible. As one example instead of providing a flow of cool air from an exterior of the silo structure into the interior channel, an opposite airflow is possible, in other embodiments. Furthermore, understand that the actual cooling arrangement can vary. In some embodiments a plurality of fans or other air circulation members can be adapted around the exterior periphery of the silo structure to enable flow of cooling air though the various racks and thus the equipment in the racks, causing heat generated by the equipment to be dissipated and flow with this flow of air into the inlet channel for exhaust out of the top. In other embodiments the flow of exhaust air can be directed to expel through a cavity at a bottom portion of the inlet channel. However, as hot air rises, a more ready solution is to provide for the flow of air exhaust up through a top portion of the inlet channel.

As briefly described above, in some implementations the silo enclosure may be implemented as a so-called rack supported structure in that the rack supporting the equipment acts as a super structure for the enclosure or building itself and the exterior of this enclosure can be formed of a relatively low cost and simple construction and installation. For example, embodiments may provide for a supporting frame or building exterior of shockcrete, preformed concrete panels or so forth. As such, the rack or other support structure that encloses the equipment is also the support structure of the building itself. Such embodiments may thus provide for greater space utilization and reduction in cooling costs as well as reduction in construction costs. In addition, given the arrangement of buildings as rack-supported structures, a datacenter business may realize greater financial return, as instead of a traditional building that is depreciated over a long term, a rack supported structure may be treated like a piece of equipment rather than a building and thus is available for accelerated depreciation.

Similar rack-supported structures may be used in other datacenter environments with a more traditional arrangement of equipment within racks of the datacenter. In these datacenters, again a building structure can be configured as a rack-supported building with the rack itself providing the super structure of the building and the exterior of the building can be formed according to a low cost construction method, such as shockcrete or preformed concrete panels, as described above.

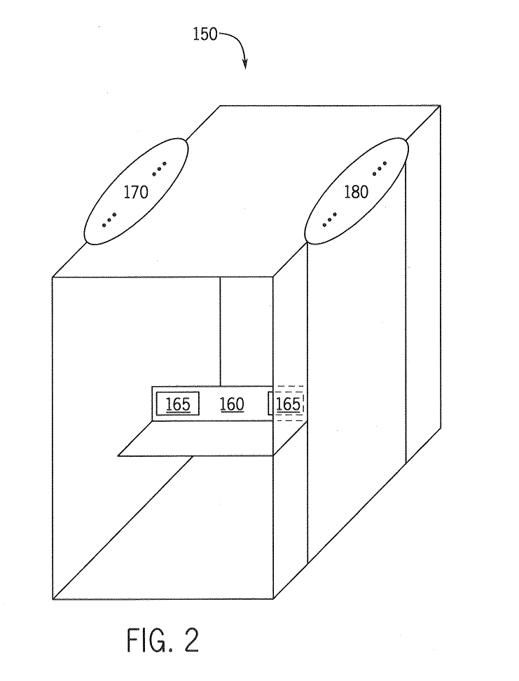

Referring now to FIG. 2, shown is a block diagram that provides further details regarding a rack or support structure in accordance with an embodiment of the present invention. As shown in FIG. 2, support structure 150 includes a midplane 160 at each level (e.g., U-height) to which various datacenter equipment can be connected via connection members 165. Note on either side of the support structure, rail members 170 and 180 are provided that enable communication of various connections to the equipment, including power and data connections. As one example, one of the rail members (e.g., rail member 170) may provide for communication of power via corresponding power cables or other power delivery mechanisms to the midplanes of the support structure.

In general, the various cables provided through the rail members may make connection with corresponding midplanes by finger-type connectors that provide power to a corresponding connector of the midplane such as a socket or blind mate connection that allows easy insertion and removal of equipment, either manually or automated via an AS/RS robotic member. On an opposing rail member (e.g., rail member 180), data connections can be provided in a similar manner. Understand that in embodiments servers or other equipment can be present on both sides of a midplane, such that a front and rear of the midplane are provided with connection members (and in some embodiments, multiple sets may be present on each side to enable installation of multiple servers or other components on each side).

Note that in some implementations regardless of the type of equipment to be installed into a rack, a single standard connector (such as connector 165) can be provided within the midplanes to provide power and data connections so that as time progresses and equipment ages, fails or so forth, simple in place replacements of one type of equipment with another type of equipment can be effected due to this common or standard connector. In some embodiments, a single connector 165 can provide for power and data connections, or different connections can be provided for power and data.

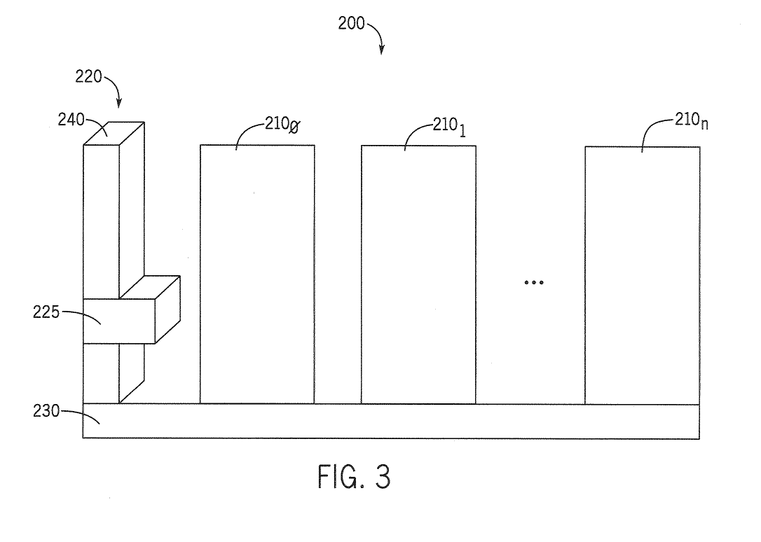

Referring now to FIG. 3, shown is a block diagram of arrangement of a datacenter in accordance with another embodiment of the present invention. As shown in FIG. 3, datacenter arrangement 200 includes a plurality of rack-based support structures 210₀-210ₙ. In an embodiment, each of these may be a conventional datacenter rack that houses various equipment, e.g., in a rack-mounted fashion such as in one or more U-height chassis to support servers and other equipment. In other implementations, instead of such conventional rack support structures (e.g., the familiar 19 inch wide rack), other support structures such as in accordance with an Open Compute specification may instead be present to support and house equipment.

In any event, datacenter 200 can be implemented with an AS/RS system 220 that enables one or more robotic members 225 to be automatically moved in both horizontal and vertical directions via a horizontal translator 230 and a vertical translator 240 (and potentially a lateral translator not shown in FIG. 3), to enable access to equipment and perform installation, maintenance and removal operations with regard to the equipment in the different support structures. Although shown at this very high level, understand that many different implementations of an AS/RS system and a support structure for the AS/RS system can be present in different embodiments. By providing a AS/RS system, a datacenter can readily populate servers and other equipment on an as needed basis. In addition, automated replacement, repair and other operations can also be performed.

To this end, a rack system may provide for power and data connections in a robotic-friendly manner. For example, power can be provided via bus bars that a robotic member can readily connect equipment into and out of. Similarly, a wide variety of data connections, both for IO, storage and so forth can be realized by a blind mating quick connect system easily performed by a robotic member such as that shown in FIG. 3.

In addition to installation and removal operations, in some embodiments an in-place downgrade of equipment and storage facilities can be provided. For example, recently and heavily used data can be maintained in storage devices located in close proximity to servers and other equipment. As data becomes less frequently used, the storage devices containing such data can be moved to a further distance from the servers and other compute equipment. In this way, the burden and expense of dynamically migrating data though a hierarchy can be avoided as instead an in-place mechanism is provided to allow the data to be moved in place, e.g., within its disk drive to a more distant location.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A system comprising:
a cylindrical frame having an internal portion surrounding and defining an open cylindrical channel and an external portion at a periphery of the cylindrical frame, the cylindrical frame including a plurality of racks at least some of which each support a plurality of servers adapted between the internal portion and the external portion, wherein a source of cooling air is communicated across the plurality of servers from the external portion to the open cylindrical channel and is exhaust therefrom.

2. The system of claim 1, further comprising at least one robotic member to access a server of the plurality of servers via the open cylindrical channel.

3. The system of claim 2, wherein each of the plurality of racks includes a plurality of midplanes each having a first side accessible by the at least one robotic member and a second side that is accessible from the external portion.

4. The system of claim 3, wherein at the least one robotic member is to insert a first server to couple to the first side of a first midplane.

5. The system of claim 4, further comprising a second server coupled to a second side of the first midplane, the second server manually insertable.

6. The system of claim 5, wherein the first midplane includes connection members to mate with corresponding connection members of the first and second servers and to provide power and a communication path to the corresponding first and second servers.

7. The system of claim 1, further comprising an exhaust fan at a top portion of the open cylindrical channel to dissipate heat from the plurality of servers.

8. The system of claim 1, wherein the cylindrical frame includes a plurality of openings each between pairs of the plurality of racks, wherein IO cables are configured within the plurality of openings and coupled to corresponding servers of the plurality of servers.

9. The system of claim 1, wherein the cylindrical frame includes a plurality of openings each between pairs of the plurality of racks, wherein the plurality of openings include air direction members to direct a flow of the cooling air across a depth dimension of the plurality of servers.

10. The system of claim 1, wherein an exterior of the cylindrical frame and the open cylindrical channel are positively isolated via a pressurized air flow.

11. A datacenter comprising:
a silo-shaped enclosure defining a shelter from an environment; and
a plurality of racks having datacenter equipment and configured within the silo-shaped enclosure, wherein the plurality of racks are configured in a substantially cylindrical arrangement that defines an interior channel to receive and expel an exhaust airflow communicated from a first side of the plurality of racks to a second side of the plurality of racks abutting the interior channel.

12. The datacenter of claim 11, wherein the silo-shaped enclosure includes a vent at top portion thereof to outlet the exhaust airflow.

13. The datacenter of claim 11, wherein the silo-shaped enclosure comprises a preformed structure sized minimally larger than the plurality of racks.

14. The datacenter of claim 11, wherein the datacenter comprises a plurality of silo-shaped enclosures each including a plurality of racks having datacenter equipment.

15. A datacenter comprising:
a plurality of racks each configured to support a plurality of rack-mounted datacenter equipment; and
an automated storage and retrieval system (AS/RS) system in communication with the plurality of racks, the AS/RS system including at least one robotic member, a lateral translator and a vertical translator, wherein the robotic member is controllable to insert a first piece of datacenter equipment into a first location within a first rack of the plurality of racks and to remove a second piece of datacenter equipment from a second location within a second rack of the plurality of racks.

16. The datacenter of claim 15, wherein the first rack includes at least one blind mate connector at the first location to enable the robotic member to insert the first piece of datacenter equipment.

17. The datacenter of claim 16, wherein the robotic member is to insert a server into the first location during installation of the server into the datacenter.

18. The datacenter of claim 15, wherein the robotic member is to remove a second server from the second location responsive to a failure in the second server.

19. The datacenter of claim 15, further comprising a building enclosure to house the plurality of racks, the building enclosure comprising a rack supported structure in which the plurality of racks form a super structure of the building enclosure and a plurality of panels are adapted to an exterior of the plurality of racks to form an exterior of the building enclosure.

20. The system of claim 15, wherein each of the plurality of racks further comprises a first rail member vertically adapted to a first side of the rack and a second rail member vertically adapted to a second side of the rack, wherein the first rail member is to supply power to the corresponding plurality of servers and the second rail member is to provide IO communication paths to the corresponding plurality of servers.

21. The system of claim 20, wherein each of the plurality of racks includes a plurality of midplanes each having a first face having a power connection member coupled to the first rail member and to couple to a corresponding power connector of a server and a data connection member coupled to the second rail member and to couple to a corresponding data connector of the server, wherein the at least one robotic member is to install the server into the first face, and a second face having a power connection member coupled to the first rail member and to couple to a corresponding power connector of a second server and a data connection member coupled to the second rail member and to couple to a corresponding data connector of the second server, the second server manually inserted into the second face.
